(19) United States
(12) Patent Application Publication
(10) Pub. No.: US 2006/0020576 A1
(43) Pub. Date: Jan. 26, 2006

(54) Search system reusing search condition and the related method

(75) Inventor: Fumiyoshi Karube, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki-shi (JP)

(21) Appl. No.: 11/239,063

(22) Filed: Sep. 30, 2005

Related U.S. Application Data
(63) Continuation of application No. PCT/JP03/07434, filed on Jun. 11, 2003.

(51) Int. Cl. G06F 17/30

(52) U.S. Cl. 707/2

(57) ABSTRACT

The provision unit stores information about a hierarchical structure of keywords constituted by each of a plurality of keywords contained in a previous search condition as elements and transmits the information in response to a request from the input unit for inputting a search condition. The input unit displays the received hierarchical structure of keywords on a display screen.

### CROSS REFERENCE TO RELATED APPLICATION

This application is a continuation application of International PCT Application No. PCT/JP2003/007434 which was filed on Jun. 11, 2003.

### BACKGROUND OF THE INVENTION

1. Field of the Invention

The present invention relates to a search system and the related method for searching for a document intended by a user from among a collection of documents created by using a data base, a collection of files, et cetera. The technique is usually called a search engine for use in searching an Internet home page, et cetera.

2. Description of the Related Art

Today, there exist diverse search engines such as search engines for use in searching Internet home pages. If one would like to conduct a search with a search condition modified a little from one used for a document search in the past, it is cumbersome to search for the stored search condition. It is, however, more cumbersome for the user to input the similar search condition again.

Conventional search engines have taken the following approaches to search conditions used for a previous search:
(1) The user is requested to input a search condition for every search action, while the engine only memorizes the search condition specified in the immediate past. Therefore, search condition is not reused.
(2) A search condition is memorized for reuse after the search engine activation, used during the activation, and erased when the search engine is deactivated. Therefore, the search condition is not reused in the next activation.
(3) A search condition is unconditionally stored by a disk, et cetera, and is reused. In this case, a log of search condition(s) will simply be stored.
(4) A search condition is stored by a disk, et cetera, and reused in accordance with the user's instructions.

As described above, there exist several methods for memorizing or storing a search condition. Meanwhile, a memorized or stored search condition is reused as follows:
(1) The latest or oldest search condition is displayed in sequence so as to allow the user to select any one of the displayed conditions. In this case, a search condition is displayed by a simple log.
(2) Search conditions are displayed by character strings, et cetera, in a sorted manner so as to allow the user select any one of the displayed conditions.
(3) A group is designated when a search condition is registered and a search condition is displayed in the unit of groups so as to allow the user to select any one of the displayed search conditions.
(4) Search conditions are displayed in a sequence of similar conditions (as groups) so as to allow the user to select any of the displayed search conditions.

When the previous search condition is displayed, the user is naturally enabled to modify a part of the selected search condition to use as a new search condition.

The conventional search engines store and display search conditions as they are specified by the user (e.g., a combination of keywords and conditions). The format of a search condition is exemplified as follows (e.g., refer to the non-patent document 1):
Keyword 1 AND keyword 2 OR (keyword 3 NOT keyword 4) . . .

In the above described conventional method of search condition display and/or reuse, however, the user has to process a displayed plurality of search conditions in the procedures of: a) reference, b) selection and c) renewal, in which a) reference, and b) selection, of the displayed conditions are cumbersome work processes. This is exacerbated when registering a search condition by specifying a group, et cetera, because the user for instance determines which search condition belongs to which group by relying on her/his own memory, thus increasing the load on the user.

Consequently, a technique is required for enabling the user to make a) reference and/or b) selection easily after a search condition is displayed.

[Non-Patent Document 1]

“Yahoo!® search help”, [online], provided by Yahoo!® Japan, [a search dated Apr. 9, 2003], Internet <URL: http://help.yahoo.co.jp/help/jp/ysearch/ysearch-15.html>

### SUMMARY OF THE INVENTION

The challenge of the present invention is to provide a search system and the related method for lightening the load on a user in the display and/or reuse of search conditions for use in a document search.

In a first aspect of the present invention, an information provision apparatus comprises storage, extraction and transmission units; and provides information about a search condition used in a previous document search to an input unit for inputting search conditions for a document search.

The storage unit stores keyword information having a hierarchical structure comprising each of a plurality of keywords included in the previous search conditions as an element. The extraction unit extracts keyword information having a hierarchical structure from the storage unit in response to a request from the input unit. And the transmission unit transmits the extracted keyword information having a hierarchical structure to the input unit.

The input unit and information provision apparatus correspond to a later described client 201 and server 202, respectively, both shown by FIG. 2, for example; the storage and extraction units correspond to a later described condition storage dictionary 223 and server mechanism 222, respectively, both shown by FIG. 2, for example; and the transmission unit corresponds to a later described network connection apparatus 1107 shown by FIG. 11 for example.

In a second aspect of the present invention, the above described storage unit, in the above described expression of a search condition comprising a plurality of keywords, if a first keyword and a second keyword are combined by a certain operator, stores the first and second keywords as elements on respectively different hierarchical levels, whereas if the second keyword and a third keyword are combined by another operator, stores the second and third keywords as elements on the same hierarchical level.

In a third aspect of the present invention, the input unit for use in inputting a search condition for a document search displays, on a display screen, keyword information having a hierarchical structure comprising each of a plurality of keywords included in the previous search conditions as an element, and displays an updated hierarchical structure of keywords when the user instructs the movement of a keyword between the hierarchical levels in the displayed hierarchical structure thereof.

The input unit corresponds to a later described client 201 shown by FIG. 2 for example.

In a fourth aspect of the present invention, a search system comprises an input unit, a provision unit, a search unit, and a document storage stack; and provides information about a search condition used in the previous document search to an input unit for use in inputting a search condition for a document search.

The input unit requests the provision unit for a previous search condition and displays information about the previous search condition received from the provision unit on a display screen. The provision unit extracts information about the previous search conditions from the storage unit to transmit to the input unit and requests a document search by the search unit in response to a request from the input unit. And the search unit searches for documents in the document storage stack in response to the request from the provision unit.

In the search system, the input unit, provision unit, search unit and document storage stack operate mutually independently, and the combinations among the input unit, provision unit, search unit and document storage stack are all freely changeable.

The input unit, provision unit, search unit and document storage stack correspond to a later described client 201, server 202, search unit 203 and document storage stack 242, respectively, shown by FIG. 2 for example.

### BRIEF DESCRIPTION OF THE DRAWINGS

FIG. 1 shows a keyword display screen;

FIG. 2 shows a comprisal of a search system;

FIG. 3 is a flow chart of the work procedure for a user;

FIG. 4 shows a data structure of a condition storage dictionary;

FIG. 5 exemplifies an embodiment of a condition storage dictionary;

FIG. 6 is a flow chart of a processing of a client mechanism;

FIG. 7 is a flow chart of a processing of a server mechanism;

FIG. 8 is a flow chart of processing of a search engine;

FIG. 9 is a flow chart of processing of a search mechanism;

FIG. 10 is a flow chart of processing of a keyword editor mechanism;

FIG. 11 shows a comprisal of an information processing apparatus; and

FIG. 12 shows storage media.

### DESCRIPTION OF THE PREFERRED EMBODIMENTS

A preferred embodiment of the present invention is described in detail while referring to the accompanying drawings as follows.

A search system according to the present embodiment is furnished by the following four significant characteristics so as to:
(1) divide the functions of the search system into search keyword display, search condition storage, a search engine and a document storage stack and adopt a mechanism so as to enable the respective functions to operate independently. This enables load distribution, independent operation and increase in degrees of freedom, making it possible to freely change combination of search key word display, search condition storage, search engine and document storage stack;
(2) enable the search keyword display function to display not only a search keyword in a hierarchical structure but also the number of hits in the previous search. This enables the user to easily predict a search result (i.e., the number of hits) in the case of searching based on the previous search condition;
(3) enable the search condition storage function to store a hierarchical structure of a search keyword and the number of hits in the previous search. This accomplishes the above described search keyword display function; and
(4) search in a plurality of document storage stacks using the same search condition. This makes it possible to search in different document stacks using the same search condition based on the result of the previous document search.

In conventional search systems, since a plurality of functions are integrated instead of being separated, there are problems such as another client being unable to use a keyword having a hierarchical structure if it is stored in a client which is displaying it, while a keyword having a hierarchical structure cannot be used for a search in another server if a keyword having the same hierarchical structure as the aforementioned keyword is stored in a server which is conducting a search, et cetera.

Contrary to the above described, a separation of the functions, i.e., search keyword display, search condition storage, search engine and document storage stack, as shown in the aforementioned paragraph (1), makes it possible to flexibly reuse a keyword having a hierarchical structure.

Meanwhile, the function of the search keyword display as described in the aforementioned paragraph (2) is enabled to display not only the hierarchical structure of a keyword but also a search condition in the conventional format by selecting a part of the hierarchical structure. This enables the user to conduct a search by copying the displayed search condition and inputting it to a conventional type search engine, et cetera, which requires a search condition in the conventional format.

Since a keyword displayed in a hierarchical structure accompanies the previous search result (i.e., the number of hits), the user is able to predict a search result (i.e., the number of hits) before performing an actual search.

The function of the search condition storage described in the aforementioned paragraph (3) also stores the number of hits as a result of conducting a search, contrary to the conventional search engine which stored a specified keyword as is. This makes it possible to present the number of hits in the previous search for the benefit of the user.

The search system according to the present embodiment is further characterized as:
(5) adding the function of an editor function for a collection of keywords for use in a search as follows:
add the reading or pronunciation of the keyword (i.e., voice data) of the search result; and
register a keyword used for a search (i.e., clause) by using an external communication means.

The addition of the reading or pronunciation to a keyword hit by the search makes it possible to display not only a catalog of keywords in Japanese syllabary order but also synonymous keywords with different pronunciation (e.g., English and Japanese words) at once.

Incidentally, there are means for adding a reading, including registration by the user and cooperation with a conversion dictionary such as conventionally available Japanese to English dictionaries, and vice versa. For example, when a search engine detects a keyword “engine,” the user can add readings such as “enjin” (NB this is a phonetic translation of Japanese “Hiragana” script converted to the Roman alphabet for the sake of explanation herein only), “ENJIN” (in “Katakana” script), “hatsudouki” (a Japanese word for “engine”), or “gendouki” (another Japanese word for “engine”) to the detected keyword.

Additionally, registration of a clause as a keyword makes it possible to conduct a search by a clause containing a plurality of combined words as a keyword, which is different from a search in the unit of individual words being matched by a usual search. Here, the clause is defined as a combination of words originally used as separate keywords respectively. For example, the clause “kensaku enjin towa” (NB again a phonetic translation of Japanese converted to the Roman alphabet, generally meaning “search engine is defined” in Japanese) consists of three words, i.e., “kensaku” (“search”), “enjin” (“engine”) and “towa” (“is defined”).

(6) The response method for a search result in the conventional search engine was either responding with a result of a search during less trafficked times such as at midnight or of an actual physical search for documents on an as required basis.

Contrarily, the present embodiment provides a selection as to whether or not to conduct a physical search when calling up a search engine so as to conduct an actual physical search if the user requests the latest document, otherwise responding with a prior search result.

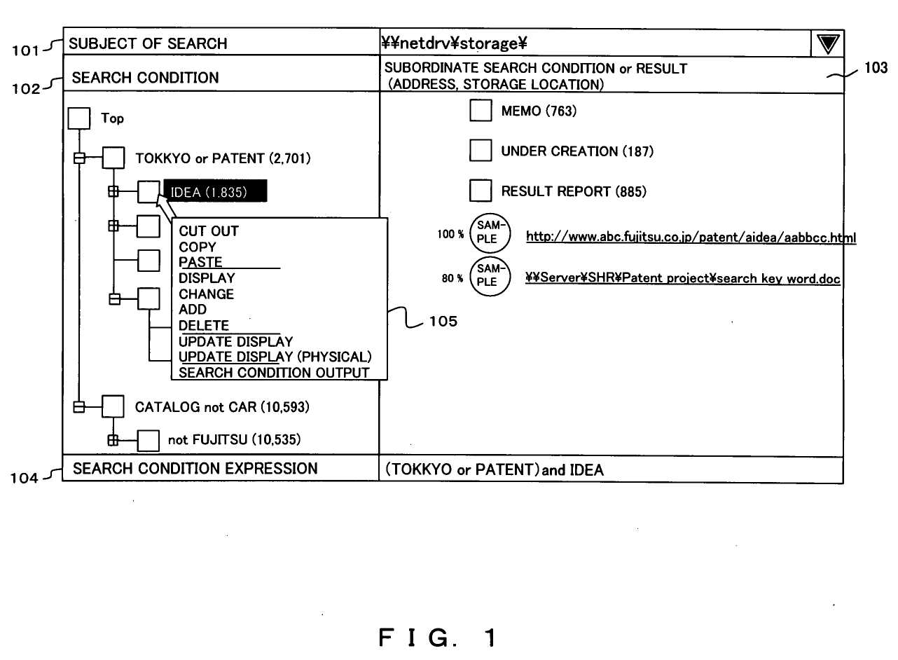

FIG. 1 shows an example of a keyword display screen according to the present embodiment. The search system assorts a keyword and a condition (i.e., operator) contained in a search condition specified by the user to store a search condition in a hierarchical structure based on a certain operator such as an AND condition, and to store the other conditions and keywords as elements of a hierarchical structure.

The screen shown by FIG. 1 includes display zones for search subject 101, a search condition 102, a subordinate search condition or result 103 and a search condition expression 104. The zone for the search subject 101 displays identification information about the searched document storage stacks, and the search condition 102 display zone displays a search condition used for the previous search in a hierarchical structure.

In this example, hierarchical structures with “Tokkyo OR PATENT” (NB “Tokkyo” means ‘patent’ in Japanese) as the initial element and with “catalog NOT car” as the initial element as the search condition 102 are shown. In the former hierarchical structure, an element “idea” is included on the level lower than “Tokkyo OR PATENT”, and in the latter hierarchical structure, an element “NOT Fujitsu” is included on the level lower than “catalog NOT car.”

If an operator is not added in front of the keyword for each element, the keyword is combined with an element on the upper level by the AND condition, since a hierarchical structure based on the AND condition is used here. Alternatively, if an operator is added in front of the keyword for each element, the keyword is combined with an element on the upper level by the aforementioned operator.

Therefore, “Tokkyo OR PATENT” and “idea” are combined by the AND condition, while “catalog NOT car” and “Fujitsu” are combined by the NOT condition.

The user is able to specify a discretionary search condition by selecting either element from among the displayed search conditions 102. For example, a user clicking “idea” with a pointing device will specify a search condition combining the “Tokkyo OR PATENT” and “idea” as follows:
(Tokkyo OR PATENT) AND idea

In this event, the subordinate search condition or result 103 displays an element on a level lower than “idea” and the result of the previous search conducted by the specified search condition (i.e., address and storage place). The search result displays information such as hit ratio, sample, storage place, size, date, et cetera.

Here, three elements, i.e., “memo”, “under creation” and “result report”, are displayed as the elements on a level lower than “idea”, with hit ratios of two documents, a sample, and an address or a storage location being displayed as the search result.

Meanwhile, the number written in parenthesis on the right side of each element in the search conditions 102 and subordinate search condition or result 103 indicates the number of hits for the previous search of the corresponding search condition.

In the case of a user reusing a previously specified search condition, the user is able to select a required search condition by visually comprehending the search condition by displaying the previous search condition in such a hierarchical structure.

The search condition operations are enabled for, cut, copy, paste, display, change, addition (creation), deletion, update display, update display (physical), and search condition output, et cetera, as shown by menu box 105. Meanwhile, the addition of a search condition is possible by creating a new element (i.e., operator and keyword) over the displayed hierarchical structure.

As for update display, it is possible to update the search result by a specified search condition by using a prior search result, while for update display (physical), it is possible to update the search result to the most recent by performing an actual document search based on the specified search condition.

As for the search result output, a hierarchically layered search condition is outputted in the conventional search condition format. In FIG. 1, the specified search condition is displayed in a search condition expression 104 in the conventional format. The user is able to obtain the same search result by the search condition using the conventional search engine just by copying the outputted search condition into the conventional search engine.

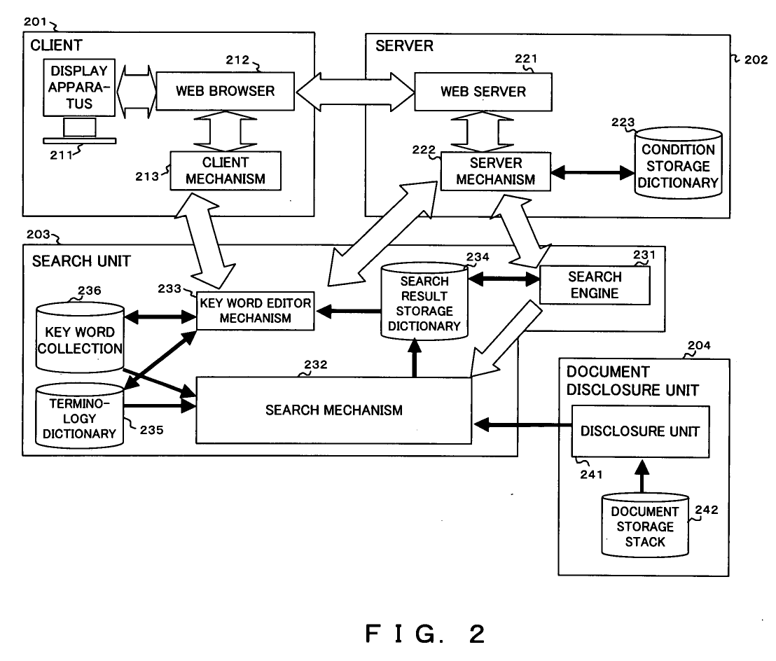

The next description is a detailed description of the comprisal and operation of the search system according to the present embodiment given while referring to FIGS. 2 through 10.

FIG. 2 shows the comprisal of a search system. The search system shown by FIG. 2 comprises a client 201, a server 202, a search unit 203 and a document disclosure unit 204. The user operates the client 201, thereby sending a processing request such as a search to the server 202 which in turn asks the search unit 203 for the requested search. The search unit 203 extracts the document information corresponding with the search condition from the document disclosure unit 204 for storage as a search result.

The client 201, server 202, search unit 203 and document disclosure unit 204 are configured as mechanisms capable of operating mutually independently in order to perform hierarchical display of search keywords.

These four mechanisms are accomplished by one or a plurality of information processing apparatus (i.e., computers). For example, if each mechanism is comprised of a mutually independent computer, these mechanisms will be connected by a communication network such as the Internet, thereby enabling interexchange of information.

Accordingly, it is possible to have an interrelationship in the numbers of units as follows. That is, the client 201: server 202: search unit 203: document disclosure unit 204=1:n:n:n. In other words, for one client 201, there can be n-number of servers 202, n-number of search units 203 and n-number of document disclosure units connected. The separation of each mechanism from each other makes it possible to easily reuse a keyword having a hierarchical structure.

The client 201 comprises a display apparatus 211 (i.e., display), a Web browser 212 (i.e., Web client) and a client mechanism 213. The server 202 comprises a Web server 221, a server mechanism 222 and a condition storage dictionary 223.

The display apparatus 211 accepts an operation input from the user and displays output information from the Web browser 212 on the display screen. The Web browser 212 is a program operating as the interface between the user and the Web server 221 which is a program operating as the interface between the Web browser 212 and server mechanism 222. The condition storage dictionary 223 is a dictionary for storing a search condition in a hierarchical structure.

The search unit 203 comprises a search engine 231, a search mechanism 232 oriented for a high speed search, a keyword editor mechanism 233, a search result storage dictionary 234, a terminology dictionary 235 and a keyword collection 236.

The search result storage dictionary 234 is a dictionary for storing a search result in order to speed up a search. The search engine 231 extracts a search result from the search result storage dictionary 234 in response to a request from the server mechanism 222 to send it back thereto.

The terminology dictionary 235 is a dictionary for registering additional information such as Japanese and English readings, meanings, usage examples, pronunciations, et cetera. The keyword collection 236 contains a collection of the user registered keywords, each of which is used by the search mechanism 232 as a search key. The keyword collection 236 stores all the keywords used in the previous searches.

The document disclosure unit 204 comprises a disclosure unit 241 and a document storage stack 242 which is a storage stack for storing document information as the subject of a search. The disclosure unit 241, being a network drive, a Web server, et cetera, discloses the document information contained in the document storage stack 242 to the network.

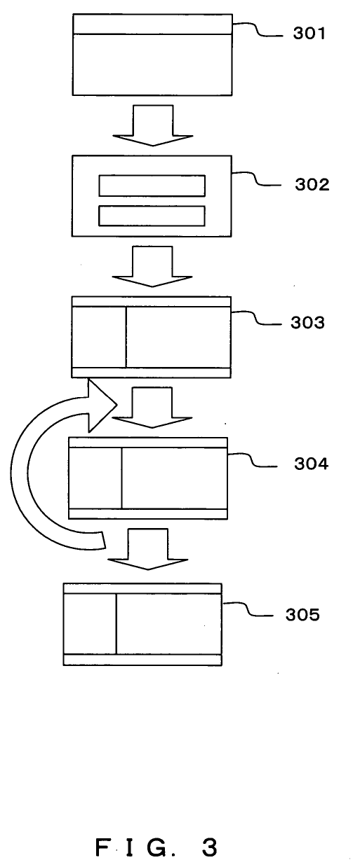

The next description is of the operation of the search system shown by FIG. 2 along with the actual work procedure for the user shown by FIG. 3.

The user first starts up the Web browser 211 on the client 201 to select one server 202 from among a plurality of servers 202 (step 301), by which a request from the user is sent to the server mechanism 222 comprised of the selected server 202, and the server mechanism 222 requests the input of a user ID and a password in order to confirm the legitimacy of the user.

Next, as the user inputs the user ID and password, the authentication information is transmitted to the server mechanism 222 (step 302), except in the case that authentication information other than the user ID and password is used, such as in the case of using a public key system.

The server mechanism 222 inspects the legitimacy of the user and, if a request from the client 201 is for a hierarchical structure of a keyword, refers to the condition storage dictionary 223 and transmits three pieces of information to the client 201 as follows:
the client mechanism 213 which performs a hierarchical display of keywords, et cetera, in the Web browser 212;
search subjects used by the user in the past (i.e., a catalog of the document storage stacks 242 used in the past); and
a hierarchical structure of keywords created (i.e., inputted) in the past.

The Web browser 212 calls up the client mechanism 213 based on the information received from the server 202 and displays the hierarchical structure of keywords on the display screen of the display apparatus 211.

Next, the user specifies a particular document storage stack as a search subject by selecting one, or direct input, in the display screen; and the client mechanism 213 transmits the information about the specified search subject to the server mechanism 222 (step 303).

The server mechanism 222 refers to the condition storage dictionary 223, extracts the number of hits corresponding to the hierarchical structure of the received keywords as the search subject used in the past and transmits it to the client mechanism 213. As a result of this processing the number of hits in previous searches along with the keywords of the hierarchical structure is displayed, except in the case that the document storage stack is newly specified in which case the number of hits is not displayed.

As the user selects a keyword in the displayed hierarchical structure, the client mechanism 213 changes the screen display accordingly to display a keyword on a lower hierarchical level (step 304), thereby enabling the user to reach the required keyword. In this event, the number of hits displayed along with each keyword makes it easy to find the required keyword.

Having reached the required keyword, the user specifies the latest display in order to confirm the latest state of the keyword. In this case, the client mechanism 213 traces the hierarchical structure upstream (i.e., toward upper levels) from the specified keyword and then creates a search condition when reaching the element on the uppermost level, thereby transmitting the following pieces of information to the server mechanism 222:
user authentication information (NB a retransmission of the authentication information between the client 201 and server 202 at every communication therebetween reduces the load on the server by cutting the communication);
the information about the search subject (i.e., information about a document storage stack(s)); and
a string of keywords from the top hierarchical level to the required keyword (NB the client mechanism 213 also performs a conversion to a series of search condition expressions at the same time).

The server mechanism 222, after confirming the authentication information of the user, transmits the received information to the search engine 231 comprised by the search unit 203.

The search engine 231 refers to the received information and the search result storage dictionary 234, creates the search result and sends it back to the server mechanism 222. If the user has specified the latest display (physical), the search mechanism 232 actually searches the document storage stack 242 and accumulates the result in the search result storage dictionary 234, followed by the search result being transmitted to the server mechanism 222.

The server mechanism 222, having received the search result, stores the number of hits in the condition storage dictionary 223 followed by transmitting the search result to the client mechanism 213 which displays the received search result on the display screen accordingly.

Then, the user selects a document from among the displayed search results (step 305) in an attempt to confirm the content of the desired document on the display screen. Since the search result contains the addresses of home pages or network drives, et cetera, the Web browser 212 refers directly to the applicable document to display on the display screen.

The comprisal shown by FIG. 2 exemplifies the case in which the Web browser 212 and Web server 221 are installed in the client 201 and server 202, respectively. The same processing, however, can be accomplished by using a dedicated screen display client application program and the corresponding screen display server application program in lieu of the Web browser 212 and Web server 221.

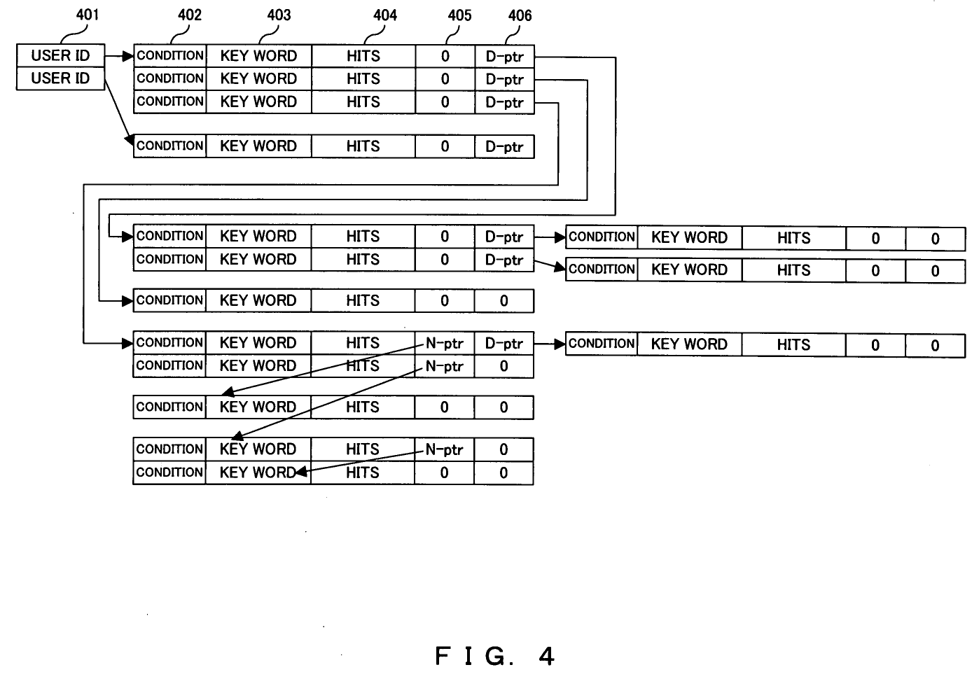

FIG. 4 shows an example data structure of the condition storage dictionary 223 which supports the operation of the server mechanism 222 in the server 202. The condition storage dictionary shown by FIG. 4 stores a plurality of hierarchical structures of keywords with a user ID as a key; and the elements constituting each hierarchical structure include a condition 402, a keyword 403, the number of hits 404, an N-pointer 405 (N-ptr) and a D-pointer 406 (D-ptr).

The condition 402 is a condition specified for an element (i.e., the operators such as OR, NOT, NER). The OR operator expresses a condition to include either one keyword theretofore or thereafter, or both keywords; the NOT operator expresses a condition not to include the specified keyword 403; and the NER operator expresses a condition to include a character string approximate to the specified keyword 403 (i.e., approximation). The number of hits 404 is the number of hits in the previous search corresponding to the search condition expressed by each element beginning from the element on the uppermost level down to the present element.

The N-pointer 405 is a pointer which addresses the next element on the same level, with a zero (“0”) being indicated if there is no next element. The D-pointer 406 is a pointer which addresses an element on the next level (i.e., lower level), with a zero (“0”) being indicated if there is no longer a lower level.

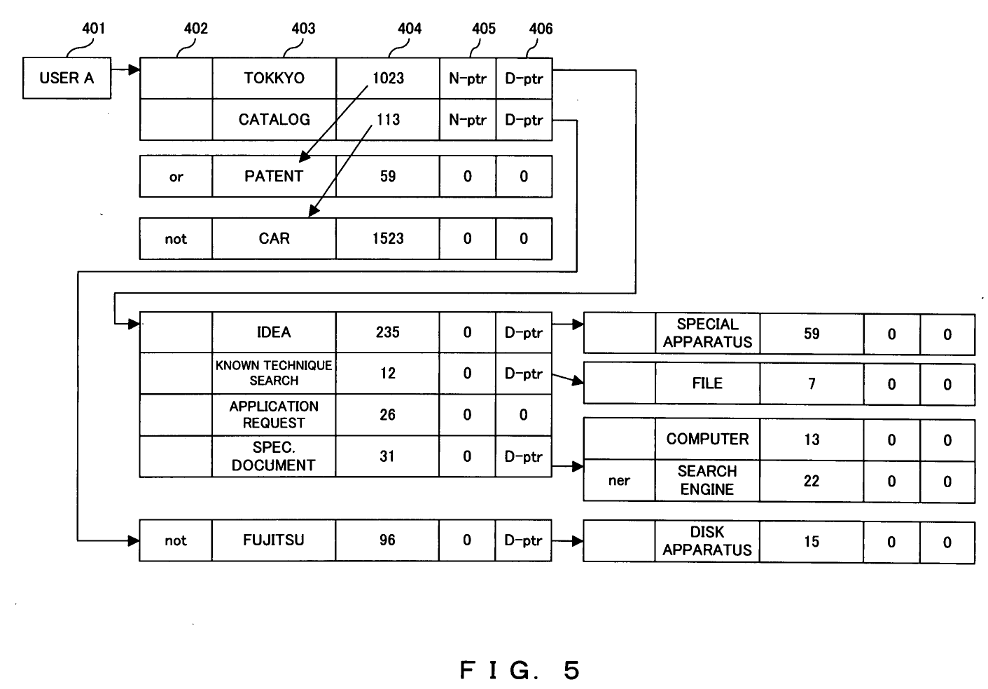

FIG. 5 exemplifies an actual hierarchical structure of keyword created by the above described data structure.

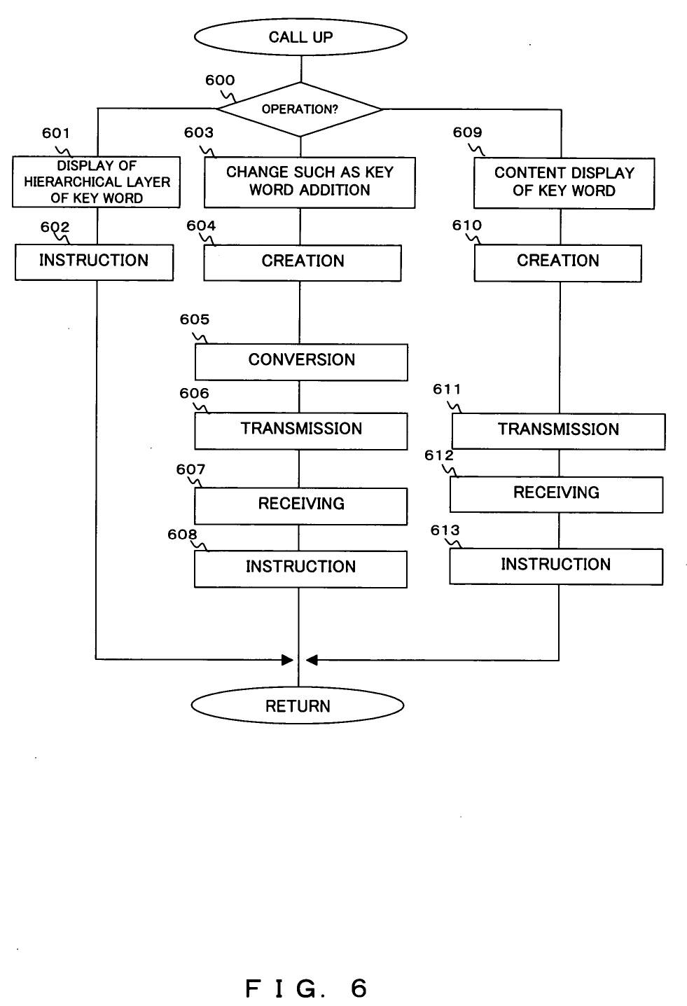

The next description is of the operation of each mechanism in detail and is given while referring to FIGS. 6 through 10.

If there is no problem in the inspection of user legitimacy following the user initially connecting with the server mechanism 222, the client mechanism 213 comprised by the client 201 will be sent from the server mechanism 222 to the Web browser 212 to operate therein.

While JAVA® applets, et cetera, are the most suitable format for the client mechanism 213, other client mechanisms 213 such as a program operating on the client 201 may be created. Incidentally, if a client mechanism 213 can be operated by the Web browser 212, the processing up to the user authentication inspection, inclusive thereof, can be done by the function of the Web browser 212 alone.

The client mechanism 213, having been called up by the Web browser 212, instructs the Web browser 212 to perform screen display based on the information received from the server mechanism 222.

Also, every time the user operates on the display screen such as selection, et cetera, the client mechanism 213 is called up by the Web browser 212 and instructs the Web browser 212 to redisplay the screen. Since the information exchange between the client mechanism 213 and Web browser 212 is based on a known technique, its description is omitted herein.

FIG. 6 is a flow chart of processing by the client mechanism 213 which first judges the user operation as soon as it is called up by the Web browser 212 (step 600).

If the user operation is a request for display of a hierarchical level of a keyword (step 601), the client mechanism 213 instructs the Web browser 212 to perform the necessary processing for the screen transition instructed by the user (step 602). As per the instruction, the Web browser 212 performs screen display, thereby prompting the following processes of:
displaying the hierarchical structure of a keyword transmitted from the server mechanism 222 along with the client mechanism 213;
displaying the keyword described by the hierarchical structure in the conventional format for a search condition. The displayed search condition can be used by other application programs such as a conventional search engine; and
displaying an updated hierarchical structure of a keyword when the user instructs movement within the hierarchical levels.

If the user operation is a change request such as addition of a keyword (step 603), the client mechanism 213 creates the information about the user instructed operation (step 604) (e.g., change, add, delete, update display, update display (physical)).

Then, converts each element ranging from the uppermost element to the specified element into a search condition expression, and transmits the created information and the search condition expressions to the server 202 (step 605), followed by receiving a response back from the server 202 (step 607), and instructing the Web browser 212 for processing to display according to the information (step 608). Having received the instruction, the Web browser 212 reconstructs a screen display, thus prompting the following processing of:
sending the information about a search subject specified by the user (i.e., the address information for the document storage stack 242) to the server mechanism 222, followed by displaying, side by side with the keyword, the number of hits sent therefrom as a result of sending the aforementioned information thereto; and
sending the information about the user's keyword operation to the server mechanism 222, followed by displaying, on the display screen, the hierarchical structure of the new keyword sent therefrom as a result of sending the aforementioned information thereto.

If the user operation is a request for content display of a keyword (step 609), the client mechanism 213 creates the information about the content display of the keyword specified by the user (step 610).

Then, the client mechanism 213 transmits the created information to the search unit 203 (step 611), receives a response back therefrom (step 612) and instructs the Web browser 212 for processing to display on the screen based on the information (step 613). Having received the instruction, the Web browser 212 performs screen display, thereby prompting the following processes of:
sending the information about the user's operation for content display of a keyword to the keyword editor mechanism 233, followed by displaying the reading, meaning, example usage, pronunciation, et cetera, of the keyword sent from the keyword editor mechanism 233 on the display screen as a result of sending the aforementioned information thereto. In this case, the display of pronunciation means the processing for outputting voice data to a speaker, et cetera; and
sending the information about the user's content operation of the keyword (e.g., register, delete or change) to the keyword editor mechanism 233, followed by displaying the reading, meaning, example usage, pronunciation, et cetera, of the keyword sent from the keyword editor mechanism 233 on the display screen as a result of sending the aforementioned information thereto.

When finishing the processing by the client mechanism 213, the client 201 returns to the processing of the Web browser 212.

The server mechanism 222 comprised by the server 202 performs the operation requested by the client 201 and responds the results thereto.

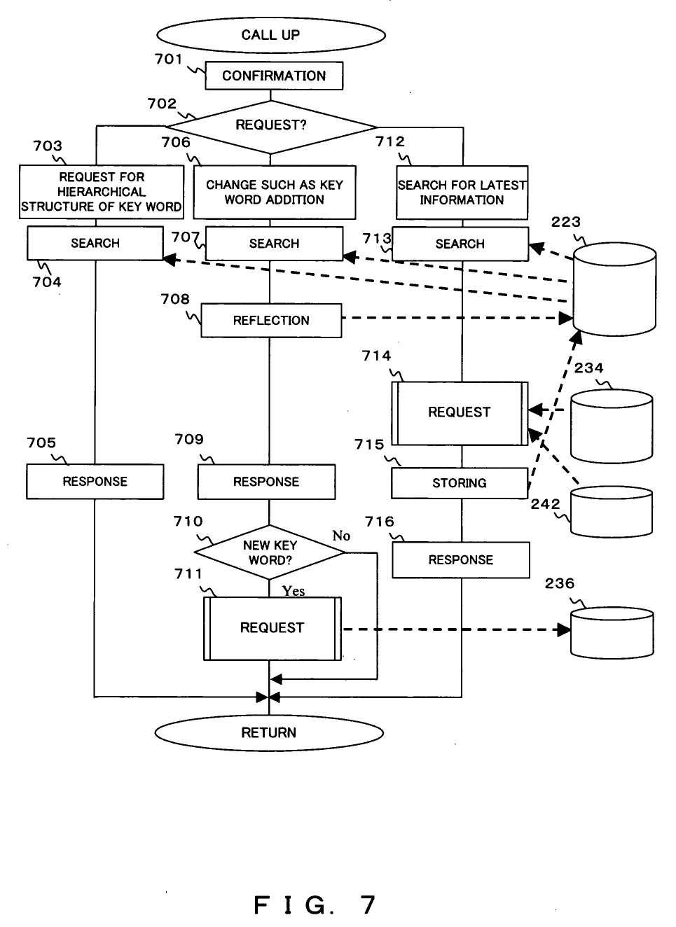

FIG. 7 is a flow chart of processing by the server mechanism 222 which first performs an inspection of user legitimacy based on the authentication information of the user as soon as it is called up by the Web server 221 (step 701) and judges a request from the client 201 (step 702).

If the request is for obtaining a hierarchical structure of keyword (step 703), the server mechanism 222 searches the condition storage dictionary 223 using the received user ID and search condition expression as the keys to obtain the information about the corresponding hierarchical structure (step 704), followed by responding to the client 201 with the obtained information about the hierarchical structure (step 705), thereby prompting the following processes of:
sending the hierarchical structures of keywords stored in the condition storage dictionary 223 to the client 201; and
sending the number of hit documents per keyword (i.e., the number of files) in the previous search as the number of hits to the client 201.

If the request is for a change such as an addition of a keyword (i.e., change, add, delete, et cetera) (step 706), the server mechanism 222 searches the condition storage dictionary 223 using the received user ID and search condition expression as the keys (step 707), and reflects the requested change content on the element in the corresponding hierarchical structure (step 708), followed by responding to the client 201 with the information about the changed hierarchical structure (step 709).

Then, judges whether or not a new keyword has been added by the change (step 710) and, if a new keyword has been added, requests addition of the keyword by the keyword editor mechanism 233 (step 711). Having received the request, the keyword editor mechanism 233 adds the new keyword to the keyword collection 236, thereby prompting the following processes of:
storing the keyword change sent from the client 201 in the condition storage dictionary 223; and
registering (i.e., transmitting thereto) the keyword stored in the condition storage dictionary 223 in the search unit 203.

If the request is for searching for the latest information (i.e., the latest display or the latest display (physical)) (step 712), the server mechanism 222 searches the condition storage dictionary 223 using the received user ID and search condition expression as the keys to obtain information about the corresponding hierarchical structure (step 713), followed by transmitting the search condition expression and the address information for the specified document storage stack 242 to the search engine 231 for requesting a search thereto (step 714). Having received the request, the search engine 231 obtains the corresponding search result from the search result storage dictionary 234 for responding to the server mechanism 222 therewith.

The server mechanism 222 stores the number of hits contained in the search result in the element of the corresponding hierarchical structure stored by the condition storage dictionary 223 (step 715) and responds to the client 201 with the search result (step 716), thereby prompting the following processes of:
requesting a search by the search unit 203 (requesting either the result of a previous search or the result of a physical search).

If the user request is for displaying the latest information, the server mechanism 222 requests the result of an already completed search by the search engine 231, and the search engine 231 extracts the result of an already completed search from the search result storage dictionary 234 to return to the server mechanism 222.

Alternatively if the user request is for displaying the latest information (physical), the server mechanism 222 makes a request for the result of a physical search by the search engine 231, while the search engine 231 instructs the search mechanism 232 to search the document storage stack 242. Then, as the search mechanism 232 stores the search result in the search result storage dictionary 234, the search engine 231 extracts the search result to send to the server mechanism 222, thereby prompting the following processes of:
receiving the search result from the search unit 203;
storing the search result, i.e., the number of hits, in the condition storage dictionary 223; and
sending the search result to the client 201.

When the processing of the server mechanism 222 is completed, the server 202 returns to the processing for the Web server 221.

The basic operation of the search engine 231 comprised by the search unit 203 is the same as that of the conventional search engine, except that the search engine 231 is furnished with the function of performing a physical search in compliance with an instruction from the server mechanism 222. Contrary to the conventional search engine returning the information registered in the search result storage dictionary 234 as the search result, the search engine 231 starts the search mechanism 232 to conduct a search when there is an instruction for a physical search, thereby enabling it to return the latest search result to the requester.

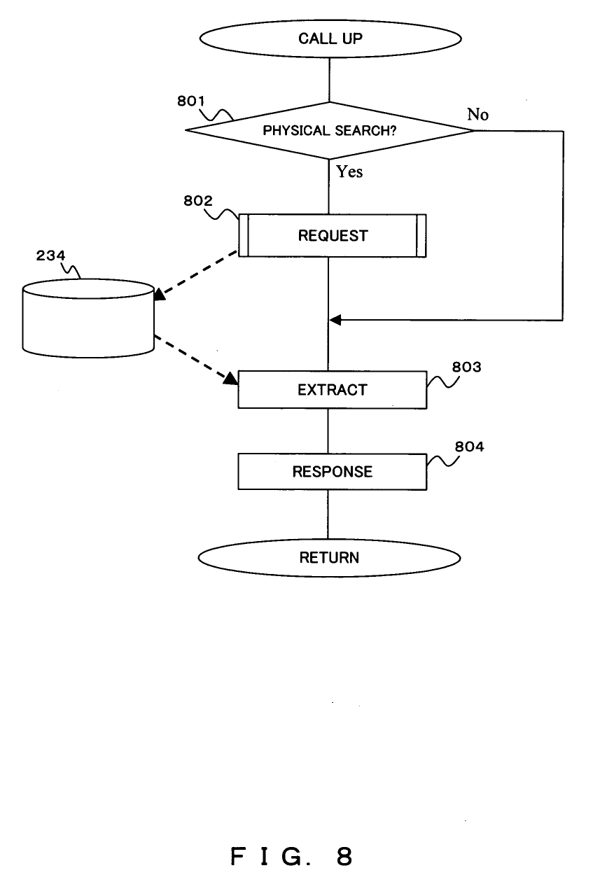

FIG. 8 is a flow chart of processing by the search engine 231 comprised by the search unit 203. The search engine 231, having been called by the server mechanism 222, first judges whether or not the request is for a physical search (step 801).

If the request is for a physical search, the search engine 231 starts the search mechanism 232 and transmits the address information for the document storage stack 242 and each keyword contained in the search condition expression thereto to request a search (step 802). If there is no request for a physical search, the search mechanism 232 will not be started up.

Then, extracts the information corresponding to the document storage stack 242 and search condition expression from the search result storage dictionary 234 (step 803) to respond back to the server mechanism 222 therewith (step 804).

The basic operation of the search mechanism 232 is the same as the conventional search mechanism, which performs document searches offline in spare time during the night, et cetera, and stores the results in the search result storage dictionary 234, however, when the search engine 231 directly specifies a keyword, the search mechanism 232 is enabled to perform a document search immediately and update the information about the applicable keyword within the search result storage dictionary 234.

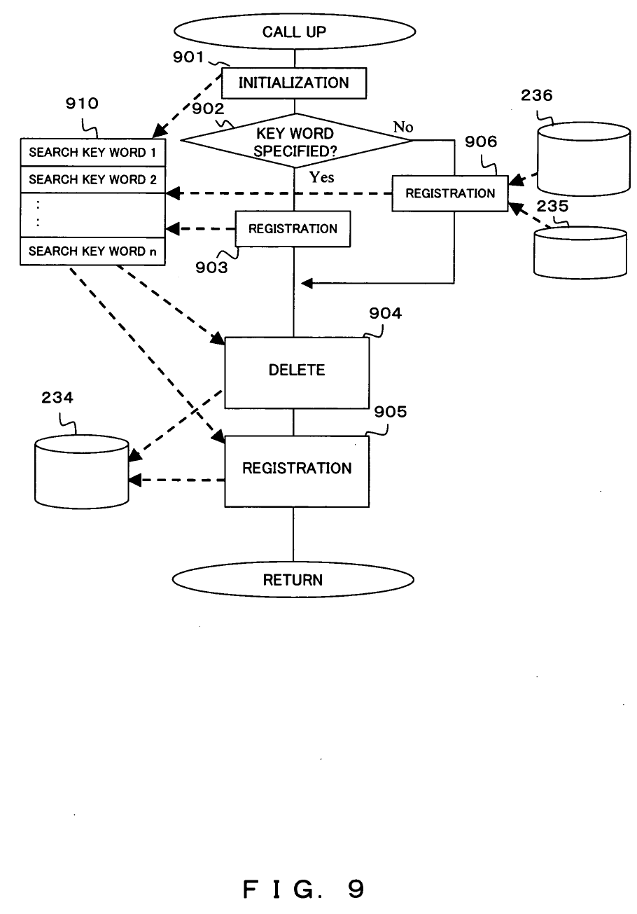

FIG. 9 is a flow chart of processing by the search mechanism 232 which starts processing either by being started periodically according to a predetermined schedule, or by being called by the search engine 231. The search mechanism 232 first initializes a keyword dictionary 910 (step 901) and judges whether or not the caller (i.e., a functional unit or function which has called; the same meaning hereinafter) has specified a keyword (step 902). The keyword dictionary 910 is a data space for temporarily storing a keyword to be used for a search and is created within memory comprised by the search unit 203.

If the search engine 231 has specified a keyword for a physical search, registers each specified keyword in the keyword dictionary 910 (step 903). Alternatively if a keyword is not specified as in the case of a periodical search, a number of keywords are created by using the keyword collection 236 and a terminology dictionary 235 for registration in the keyword dictionary 910 (step 906).

Then, deletes the information corresponding to each keyword registered in the keyword dictionary 910 among the search results within the search result storage dictionary 234 related to the specified document storage stack 242 (step 904). Here, the specified document storage stack 242 means either the previously specified document storage stack 242 for periodical execution or the one specified by the search engine.

Then, extracts the information applicable to each keyword for the keyword dictionary 910 from the specified document storage stack 242 to register in the search result storage dictionary 234 (step 905). In this event, unlike the conventional method, registers the number of hits for each keyword as well. The step 905 performs the following processes of:
reading a document in the document storage stack 242;
creating a keyword dictionary 910 from the keyword collection 236 and terminology dictionary 235;
extracting a keyword of the keyword dictionary 910 existing in the read document;
categorizing the relationship between a keyword and document for each keyword of the keyword dictionary 910, registering it in the search result storage dictionary 234 and adding the number of hits;
extracting single words existing within the read document (e.g., in the case of a keyword being a clause which contains a plurality of single words); and
categorizing the relationship between a single word and a document for each individual word, registering it in the search result storage dictionary 234 and adding the number of hits.

When the processing by the search mechanism 232 is completed, the search unit 203 returns to the processing for the caller.

The keyword editor mechanism 233 comprised by the search unit 203 is called either by the client mechanism 213 or the server mechanism 222 to execute the processing according to the instructions.

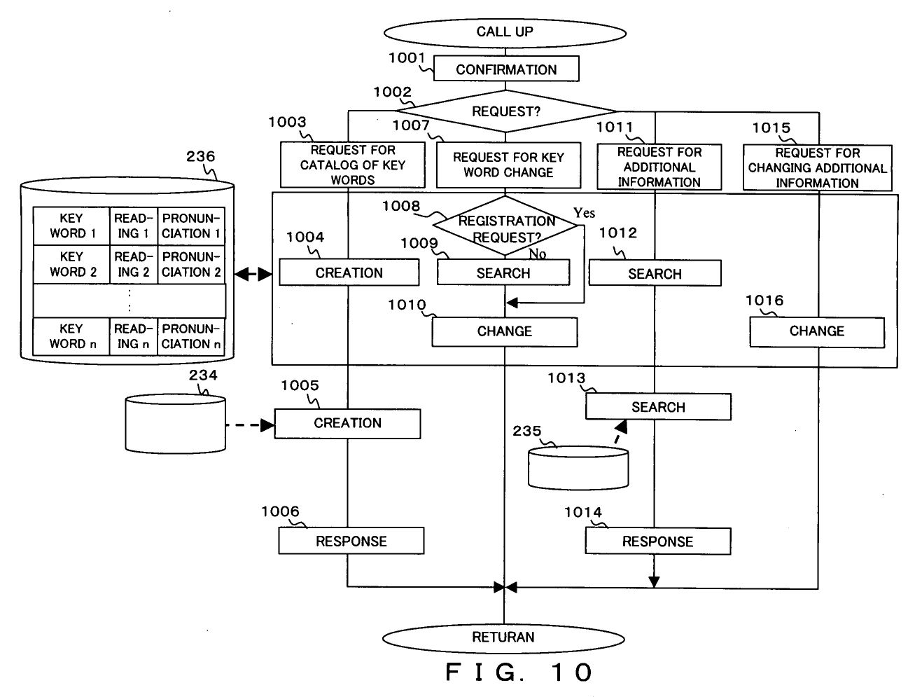

FIG. 10 is a flowchart of processing by the keyword editor mechanism 233. Having received the user authentication information from the caller, the keyword editor mechanism 233 first inspects the user legitimacy (step 1001) and judges the request from the caller (step 1002).

A request for a catalog of keywords (step 1003) and a request for changing a keyword (step 1007) are sent from the client mechanism 213 to the keyword editor mechanism 233 by way of the server mechanism 222. Meanwhile, a request for additional information (step 1011) and a request for changing additional information (step 1015) are sent directly from the client mechanism 213 to the keyword editor mechanism 233.

As to requests for a catalog of keywords (step 1003), the keyword editor mechanism 233 creates a catalog of keywords of the keyword collection 236 (step 1004) and a catalog of keywords of the search result storage dictionary 234 (step 1005), and merges the two catalogs into one table to send back to the server mechanism 222 (step 1006), thereby prompting the following processes of:
extracting keywords from the search result storage dictionary 234 and the keyword collection 236, creating a list of the number of hits for each keyword and displaying them on the screen of the client 201.

For a request for changing a keyword (step 1007), the keyword editor mechanism 233 first judges whether or not it is a request for registering a new keyword (i.e., keyword addition processing) (step 1008) and, if it is not a request for registering a keyword, searches for a keyword as a change subject from the keyword collection 236 (step 1009), followed by performing the requested change for the keyword collection 236 (step 1010), thereby prompting the following processes of:
reflecting the operation for the displayed catalog of keywords, e.g., register, delete and change, of the keyword collection 236. In particular, it is possible to register a clause consisting of a plurality of single words when registering a new keyword; and
reflecting the operation for a keyword displayed in a hierarchical structure to the keyword collection 236.

As to a request for additional information (step 1011), the keyword editor mechanism 233 searches for the requested keyword in the keyword collection 236 (step 1012) and searches for additional information about the requested keyword, e.g., reading, meaning, usage examples and pronunciation, in the terminology dictionary 235 (step 1013), followed by sending these search results back to the client mechanism 213 (step 1014), thereby prompting the following processes of:
extracting additional information about the displayed catalog of keywords, e.g., reading, meaning, usage examples and pronunciation, from the terminology dictionary 235 and the keyword collection 236, and displaying it on the screen of the client 201. In this event, the client mechanism 213 is enabled to display the indices of a Japanese syllabary order (i.e., a, i, u . . . , ka, ki, ku . . . through n), of the alphabet (i.e., a through z), et cetera, according to the reading of keywords for example.

As to requests for changing additional information (step 1015), the keyword editor mechanism 233 changes the additional information for the keyword collection 236 as requested (step 1016), thereby prompting the following processing of:
reflecting the operation for the additional information about the displayed catalog of keywords, e.g., register, delete and change, on the keyword collection 236.

In the above described search system shown by FIG. 2, the client mechanism 213, the server mechanism 222 and the search mechanism 232 are installed in respectively different computers, these mechanisms, however, may be installed in one computer. Meanwhile, in the hierarchical structure of a keyword shown by FIG. 1, the hierarchical structure is generated based on the AND condition, however such a hierarchical structure may also be generated based on the OR condition, et cetera.

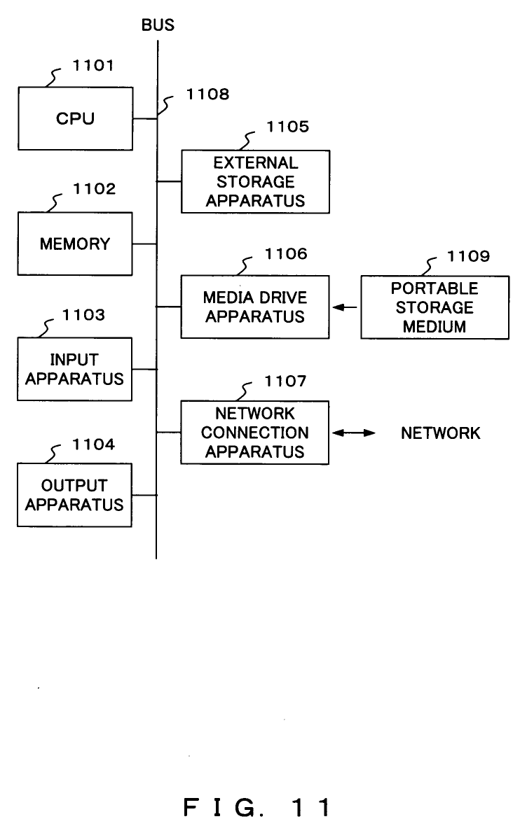

The client 201, server 202, search unit 203 and document disclosure unit 204 can be comprised by an information processing apparatus (i.e., computer) as shown by FIG. 11. The information processing apparatus shown by FIG. 11 comprises a CPU (central processing unit) 1101, memory 1102, an input apparatus 1103, an output apparatus 1104, an external storage apparatus 1105, a media drive apparatus 1106 and a network connection apparatus 1107, with a bus 1108 interconnecting the aforementioned components.

The memory 1102, comprising of ROM (read only memory), RAM (random access memory), et cetera, stores a program and data for use in processing. The CPU 1101 performs necessary processing when executing the program by using the memory 1102.

Those components shown by FIG. 2, i.e., the Web browser 212, client mechanism 213, Web server 221, server mechanism 222, search engine 231, search mechanism 232, keyword editor mechanism 233 and disclosure unit 241, correspond to the programs stored in the memory 1102.

The input apparatus 1103, comprised of a keyboard, pointing device, touch panel, et cetera, for example, is used for inputting instructions and information by the operator (i.e., user). The output apparatus 1104, comprised of a display, printer, speaker, et cetera, for example, is used to query operator and output of the processing result. The display apparatus 211 shown by FIG. 2 functions both as input apparatus 1103 and output apparatus 1104.

The external storage apparatus 1105 is comprised of a magnetic disk, optical disk, magneto optical disk, tape apparatuses for example. The information processing apparatus stores the above described program and data in the external storage apparatus 1105 and uses them by loading them into the memory 1102 on an as required basis. The external storage apparatus 1105 is also used as shown by FIG. 2, i.e., for the condition storage dictionary 223, search result storage dictionary 234, terminology dictionary 235, keyword collection 236 and document storage stack 242.

The media drive apparatus 1106 drives a portable storage medium 1109 to access recorded content therein. The portable storage medium 1109 is comprised of discretionary computer readable storage media such as a memory card, flexible disk, CD-ROM (compact disk read only memory), optical disk and magneto optical disk. The operator stores the above described program and data in the portable storage medium 1109 and uses them by loading them into the memory 1102 on an as required basis.

The network connection apparatus 1107 is connected to a discretionary communications network, such as a LAN (local area network) or the Internet, and performs data exchange in association with the communication. The information processing apparatus obtains the above described program and data from an external apparatus by way of the network connection apparatus 1107 to load them into the memory 1102 on an as required basis.

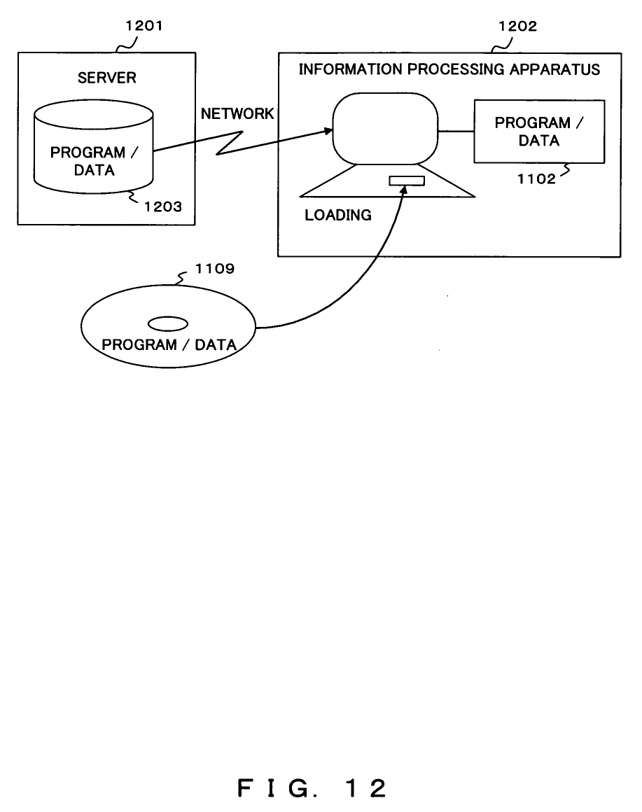

FIG. 12 shows a computer readable storage medium capable of supplying a program and data to the information processing apparatus shown by FIG. 11. A program and data stored by the portable storage medium 1109 or a data base 1203 comprised by a server 1201 are loaded into the memory 1102 comprised by the information processing apparatus 1202. The server 1201 generates a carrier signal for carrying the program and data to transmit the program and data to the information processing apparatus 1202 by way of a random transmission medium on the network. The CPU 1101 performs necessary processing by executing the program by using the data.

According to the present invention, the following benefits can be expected in the display and/or reuse of search conditions for a document search:
a capability of displaying the previous search condition visually for reuse reduces the user load; and
a capability of simply adding a new condition to the previous search condition.

Contrary to the conventional technique in which a keyword that is used, or created automatically, at the time of starting a search engine, the present invention is capable of providing a keyword to the search mechanism, which is oriented for a high speed search, during offline operation. This makes it possible to be ready with a search result required when starting the search engine, by storing the search result in the search result storage dictionary, thereby the following benefit is expected:
it is possible to speed up a search because the predicted search result is stored in the search result storage dictionary.

Furthermore, the user can expect benefits as the result of storing the number of hits for each keyword as the search result performed by the search mechanism, which is oriented for a high speed search, and displaying the results in an index such as Japanese syllabary order, alphabetical order, et cetera, as follows:
it is possible to search by a combination of keywords considered to extract a relatively small number of hits and narrow down the search result effectively; and
it is possible to refer to analects of search keywords in order to utilize as the reference materials for a search.

What is claimed is:

1. An information provision apparatus which provides an input unit for inputting a search condition for a document search with information about a search condition used for a previous document search, comprising:
a storage unit for storing information about a hierarchical structure of keywords constituted by each of a plurality of keywords contained in the previous search condition as elements;
an extraction unit for extracting information about the hierarchical structure of keywords from the storage unit in response to a request from the input unit; and
a transmission unit for transmitting the extracted information about a hierarchical structure of keywords to the input unit.

2. A computer readable storage medium for storing a search condition provision program for use by a provision unit for providing an input unit that inputs a search condition for a document search with information about a search condition used for a previous document search, wherein the search condition provision program makes the provision unit execute the processes of
extracting information about a hierarchical structure of keywords constituted by each of a plurality of keywords contained in the previous search condition as elements from a storage unit in response to a request from the input unit; and
transmitting the extracted information about a hierarchical structure of keywords to the input unit.

3. The computer readable storage medium according to claim 2, wherein said storage unit, in a search condition expression made up of said plurality of keywords, stores a first keyword and a second keyword as elements on respectively different hierarchical levels when the first and second keywords are connected by a certain operator, while storing the second keyword and a third keyword as elements on the same hierarchical level when the second and third keywords are connected by another operator.

4. The computer readable storage medium according to claim 2, wherein said storage unit stores a keyword of each element constituting said hierarchical structure of keywords by adding the number of hits in said document search carried out previously, and said provision unit transmits information about the hierarchical structure of keywords added by the aforementioned number of hits.

5. The computer readable storage medium according to claim 2, further recording a keyword editor program for use by a search unit for carrying out a document search in response to a request from said provision unit, wherein the keyword editor program makes the search unit carry out processing of transmitting at least one additional piece of information from among those, i.e., reading, meaning, usage example and pronunciation, of each keyword to said input unit in response to a request therefrom; and the input unit displays a catalog of keywords including the received additional information on a display screen.

6. The computer readable storage medium according to claim 5, wherein said input unit displays a catalog of said keywords in an indexing order of said reading when receiving the reading of each keyword as said additional information.

7. The computer readable storage medium according to claim 2, further recording a search program for use by a search unit for carrying out a document search in response to a request from said provision unit, wherein
said search condition provision program makes the provision unit execute processing of requesting a document search by the search unit by specifying a category of request for either a result of a document search already carried out or a result of an actual search for the current document; and
the search program makes the search unit carry out the processes of transmitting a prior stored result of a document search already carried out to the provision unit if the provision unit requests a result of a document search already carried out, while transmitting a result of a document search by actually carrying out said search to the provision unit if the provision unit requests a result of an actual search for the current document.

8. A computer readable storage medium for storing a search condition input program for use by an input unit for inputting a search condition for a document search, wherein the search condition input program makes the input unit execute the processes of
displaying information about a hierarchical structure of keywords constituted by each of a plurality of keywords contained in a previous search condition as elements on a display screen; and
displaying an updated hierarchical structure of keywords when a user instructs a movement between hierarchical levels within a displayed hierarchical structure of keywords.

9. A computer readable storage medium for storing a search condition input program for use by an input unit for inputting a search condition for a document search, a search condition provision program for use by a provision unit for providing the input unit with information about a search condition used for a previous document search and a search program for use by a search unit for carrying out a document search in response to a request from the provision unit, wherein
the search condition provision program makes the provision unit execute the processes of extracting information about the search condition used for the previous document search from a storage unit to transmit to the input unit in response to a request therefrom, and requesting a document search by the search unit in response to a request from the input unit;
the search condition input program makes the input unit execute the processing of displaying, on a display screen, information about a previously used search condition which is received from the provision unit;
the search program makes the search unit execute the processing of searching a document in a document storage stack in response to a request from the provision unit; and
the input unit, provision unit, search unit and document storage stack operate mutually independently, and the combinations among the input unit, provision unit, search unit and document storage stack can be freely changed.

10. A search condition provision program for use by a provision unit for providing an input unit for inputting a search condition for a document search with information about a search condition used for a previous document search, making the provision unit execute the processes of
extracting information about a hierarchical structure of keywords constituted by each of a plurality of keywords contained in the previous search condition as elements from a storage unit in response to a request from the input unit; and
transmitting the extracted information about a hierarchical structure of keywords to the input unit.

11. The search condition provision program according to claim 10, wherein said storage unit, in a search condition expression consisting of said plurality of keywords, stores a first keyword and a second keyword as elements on respectively different hierarchical levels when the first and second keywords are connected by a certain operator, while storing the second keyword and a third keyword as elements on the same hierarchical level when the second and third keywords are connected by another operator.

12. The search condition provision program according to claim 10, wherein said storage unit stores a keyword of each element constituting said hierarchical structure of keywords by adding the number of hits in said previous document search, and said provision unit transmits information about the hierarchical structure of keywords added by the aforementioned number of hits.

13. A program comprising the search condition provision program according to claim 10 and a keyword editor program for use by a search unit for carrying out a document search in response to a request from said provision unit, wherein
the keyword editor program makes the search unit carry out a process of transmitting at least one additional piece of information from among those, i.e., reading, meaning, usage example and pronunciation, of each keyword to said input unit in response to a request therefrom, and
the input unit displays a catalog of keywords including the received additional information on a display screen.

14. The program according to claim 13, wherein said input unit displays a catalog of said keywords in an indexing order of said reading when receiving the reading of each keyword as said additional information.

15. A program comprising the search condition provision program according to claim 10 and a search program for use by a search unit for carrying out a document search in response to a request from said provision unit, wherein
said search condition provision program makes the provision unit execute processing of requesting a document search by the search unit by specifying a category of request for either a result of a document search already carried out or a result of an actual search for the current document; and
the search program makes the search unit carry out the process of transmitting a previously stored result of a document search already carried out to the provision unit if the provision unit requests a result of a document search already carried out, while transmitting a result of a document search by actually carrying out said search to the provision unit if the provision unit requests a result of an actual search for the current document.

16. A search condition input program, for use by an input unit for inputting a search condition for a document search, making the input unit execute the processes of
displaying information about a hierarchical structure of keywords constituted by each of a plurality of keywords contained in a previous search condition as elements on a display screen; and
displaying an updated hierarchical structure of keywords when a user instructs a movement between hierarchical levels within a displayed hierarchical structure of keywords.

17. A program comprising a search condition input program for use by an input unit for inputting a search condition for a document search, a search condition provision program for use by a provision unit for providing the input unit with information about a search condition used for a previous document search and a search program for use by a search unit for carrying out a document search in response to a request from the provision unit, wherein
the search condition provision program makes the provision unit execute the processes of extracting information about the search condition used for the previous document search from a storage unit to transmit to the input unit in response to a request therefrom, and requesting a document search by search unit in response to a request from the input unit;
the search condition input program makes the input unit execute the process of displaying, on a display screen, information about a search condition used previously which is received from the provision unit;
the search program makes the search unit execute the processing of searching a document in a document storage stack in response to a request from the provision unit; and
the input unit, provision unit, search unit and document storage stack operate mutually independently, and the combinations among the input unit, provision unit, search unit and document storage stack can be freely changed.

18. A carrier signal for carrying a search condition provision program for use by a provision unit for providing an input unit for inputting a search condition for a document search with information about a search condition used for a previous document search, wherein the search condition provision program makes the provision unit execute the processes of
extracting information about a hierarchical structure of keywords constituted by each of a plurality of keywords contained in the previous search condition as elements from a storage unit in response to a request from the input unit; and
transmitting the extracted information about a hierarchical structure of keywords to the input unit.

19. A carrier signal for carrying a search condition input program for use by an input unit for inputting a search condition for a document search, wherein the search condition input program makes the input unit execute the processes of
displaying information about a hierarchical structure of keywords constituted by each of a plurality of keywords contained in a previous search condition as elements on a display screen; and
displaying an updated hierarchical structure of keywords when a user instructs a movement between hierarchical levels within a displayed hierarchical structure of keywords.

20. An information provision method which provides an input unit for inputting a search condition for a document search with information about a search condition used for a previous document search, comprising the steps of
storing, in a storage unit, information about a hierarchical structure of keywords constituted by each of a plurality of keywords contained in previous search conditions as elements;
extracting information about the hierarchical structure of keywords in response to a request from the input unit; and
transmitting the extracted information about a hierarchical structure of keywords to the input unit.

21. An information provision method which provides an input unit for inputting a search condition for a document search with information about a search condition used for a previous document search, wherein
the input unit requests a provision unit for the previous search condition;
the provision unit extracts the information about the previous search condition from a storage unit to transmit to the input unit in response to a request therefrom;
the input unit displays the information about the previous search condition received from the provision unit on a display screen;
the provision unit requests a document search by a search unit in response to a request from the input unit;
the search unit searches a document in a document storage stack in response to a request from the provision unit;
the input unit, provision unit, search unit, and document storage stack operate mutually independently; and
the combinations among the input unit, provision unit, search unit and document storage stack can be freely changed.
